(19) United States
(12) Patent Application Publication
(10) Pub. No.: US 2003/0005091 A1
(43) Pub. Date: Jan. 2, 2003

(54) Method and apparatus for improved monitoring in a distributed computing system

(75) Inventors: Lorin Evan Ullmann, Austin, TX (US); Jason Benfield, Austin, TX (US); Julianne Yarsa, Austin, TX (US); Oliver Yehung Hsu, Austin, TX (US)

Correspondence Address: Anne Vachon Dougherty, 3173 Cedar Road, Yorktown Heights, NY, 10598, US

(73) Assignee: International Business Machines Corporation, Armonk, NY

(21) Appl. No.: 09/896,591

(22) Filed: Jun. 29, 2001

(51) Int. Cl. G06F 15/177

(52) U.S. Cl. 709/220; 709/223; 709/224

(57) ABSTRACT

A system and method having multiple instances of polling engines at IP drivers, wherein the multiple polling engines are monitoring to discover the same network scope. The polling engines' polling intervals are staggered so that the polling communications do not unnecessarily clog the network and so that an apparent response time can be realized in the aggregate results of multiple instance polling. Unique IDs are used to differentiate which engine's status data is being used at any given time, should follow-up be required.

### FIELD OF THE INVENTION

This invention relates to distributed computing systems and more particularly to a system and method for providing fault tolerance in status and discovery monitoring without unduly burdening the system.

### BACKGROUND OF THE INVENTION

Distributed data processing networks may have thousands of nodes, or endpoints, which are geographically dispersed. In such a distributed computing network, the computing environment is optimally managed in a distributed manner with a plurality of computing locations running distributed kernels services (DKS). The managed environment can be logically separated into a series of loosely connected managed regions in which each region has its own management server for managing local resources. The management servers coordinate activities across the network and permit remote site management and operation. Local resources within one region can be exported for the use of other regions in a variety of manners. A detailed discussion of distributed network services can be found in co-pending patent application Ser. No. 09/738,307 filed on Dec. 15, 2000, entitled “METHOD AND SYSTEM FOR MANAGEMENT OF RESOURCE LEASES IN AN APPLICATION FRAMEWORK SYSTEM”, the teachings of which are herein incorporated by reference.

Realistically, distributed networks can comprise millions of machines (each of which may have a plurality of endpoints) that can be managed by thousands of control machines. As set forth in co-pending U.S. patent application Ser. No. 09/740,088 filed Dec. 18, 2000 and entitled “Method and Apparatus for Defining Scope and for Ensuring Finite Growth of Scaled Distributed Applications”, the teachings of which are hereby incorporated by reference, the distributed control machines run Internet Protocol (IP) Driver Discovery/Monitor Scanners which poll the endpoints and gather and store status data, which is then made available to other machines and applications. Such a distributed networked system must be efficient or else the status communications alone will suffocate the network.

A network discovery engine for a distributed network comprises at least one IP DRIVER. For vast networks, a plurality of distributed IP drivers are preferably, with each performing status and other communications for a subset of the network's resources. As discussed in the aforementioned patent applications, carefully defining a driver's scope assures that status communications are not duplicative.

While duplication of status and discovery monitoring has been avoided, there is still a need to provide fault tolerance in a distributed scalable application environment. Synchronously managing a single resource in parallel is problematic since a simple redundant discovery/status update is not desirable due to bandwidth, memory and storage limitations in a vast network. In addition, a stand-alone application, such as Netview, which gathers both status and discovery over several different machines can not provide aggregate status from other machines. Furthermore, such a stand-alone application can only provide status at a status interval which is equal to or greater than its longest network call code path. Therefore, if, for example, ping status takes 5 minutes, then the shortest interval that can be promised to customers is 5 minutes (a value which will vary greatly in proportion to the number of endpoints that are being managed).

It is desirable and an object of the present invention, therefore, to provide a system and method having an improved apparent response time for a network monitor to deliver status and discovery information.

It is another object of the invention to provide a system and method whereby polling latency for the network can be minimized without adversely affecting bandwidth and storage.

It is still another object of the present invention to provide a system and method whereby aggregate status from different network machines can be provided at regular, low latency intervals.

Yet another object of the present invention is to provide a system and method for optimizing polling intervals for a plurality of polling devices to meet quality of service objectives for polling output.

### SUMMARY OF THE INVENTION

The foregoing and other objectives are realized by the present invention which provides a system and method having multiple instances of polling engines at IP drivers, wherein the multiple polling engines are monitoring to discover the same network scope. The polling engines' polling intervals are staggered so that the polling communications do not unnecessarily clog the network and so that an apparent response time can be realized in the aggregate results of multiple instance polling. Unique IDs are used to differentiate which engine's status data is being used at any given time, should follow-up be required.

### BRIEF DESCRIPTION OF THE DRAWINGS

The invention will now be described in greater detail with specific reference to the appended drawings wherein:

FIG. 1 provides a schematic representation of a distributed network in which the present invention may be implemented;

FIG. 2 provides a schematic representation of the server components which are used for implementing the present invention;

FIG. 3 provides a more detailed schematic block diagram of the components of an IP DRIVER for use in the present invention;

FIG. 4 provides a block diagram showing the graphical user interface (GUI) for configuring the concurrent staggered poll engine (CSPE) in accordance with the present invention;

FIG. 5 is a flowchart depicting a process for configuring IP drivers with coextensive scope as per the present invention; and

FIG. 6 is a flowchart depicting a process for implementing monitoring in accordance with the present invention.

### DESCRIPTION OF THE PREFERRED EMBODIMENT

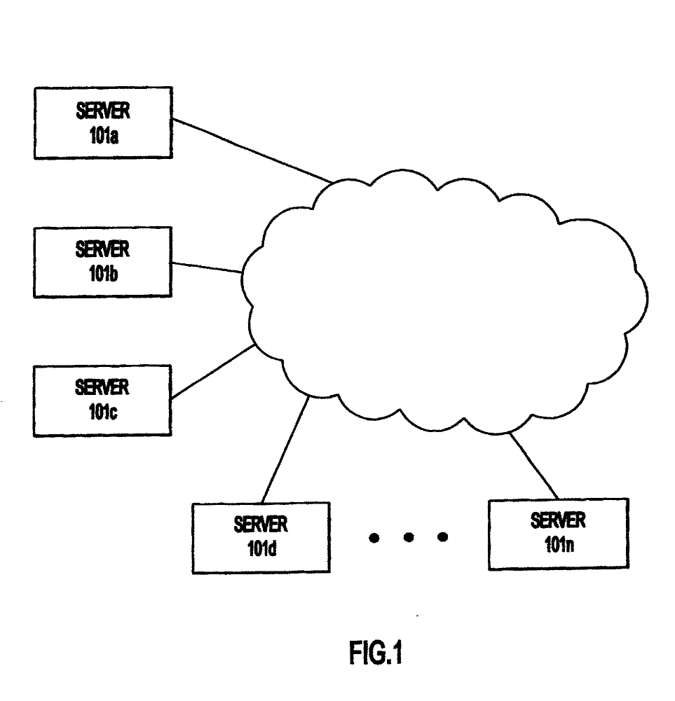

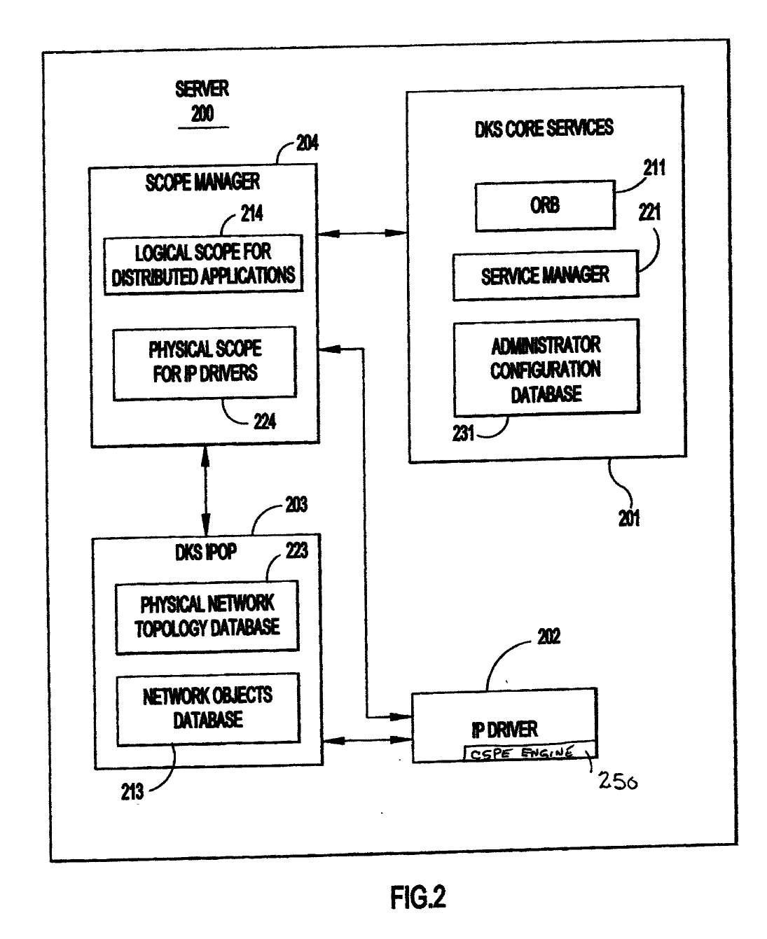

The present invention can be implemented in any network with multiple servers and a plurality of endpoints; and is particularly advantageous for vast networks having hundreds of thousands of endpoints and links therebetween. FIG. 1 provides a schematic illustration of a network for implementing the present invention. Among the plurality of servers, 101a-101n as illustrated, at least one of the servers, 101a in FIG. 1, which already has distributed kernel services (DKS) is designated as one of the control servers for the purposes of implementing the invention. A network has many endpoints, with endpoint being defined, for example, as one Network Interface Card (NIC) with one MAC address, IP Address. The control server 101a in accordance with the present invention has the components illustrated in FIG. 2 in addition to the distributed kernel services, for providing a method including the steps of: discovering the network topology and physical scope for network devices; regularly updating the status of endpoints using the physical network topology; updating the network topology based on discovery of changes to the network topology; and, providing status input in accordance with a predefined interval.

As shown in FIG. 2, the server 200 includes the already-available DKS core services at component 201, which services include the object request broker (ORB) 211, service manager 221, and the Administrator Configuration Database 231, among other standard DKS services. The DKS Internet Protocol Object Persistence (IPOP) Manager 203 provides the functionality for gathering network data, as is detailed in the co-pending patent application entitled “METHOD AND SYSTEM FOR MANAGEMENT OF RESOURCE LEASES IN AN APPLICATION FRAMEWORK SYSTEM”, Serial No. 09/738,307, filed on Dec. 15, 2000, the teachings of which are incorporated by reference herein (Docket AUS9-2000-0699).

In accordance with the functionality of the DKS IPOP, endpoint data are gathered for use by the DKS Scope Manager 204, the functions of which are further detailed below. A Network Objects database 213 is provided at the DKS IPOP Manager 203 for storing the information which has been gathered regarding network objects. The DKS IPOP also includes a Physical Network Topology Database 223. The Physical Network Topology Database will receive input from the inventive Concurrent Staggered Poll Engine (CSPE) which is further detailed below. The CSPE comprises a distributed polling engine made up of a plurality of IP Drivers, such as 202, which are, as a service of DKS, provided to discover the physical network and to continually update the status thereof. As detailed in the aforementioned patent application, the topology/polling engine can discover the endpoints, the links between endpoints, and the routes comprising a plurality of links, and provide a topology map. Regularly updating the status and topology information will provide a most accurate account of the present conditions in the network.

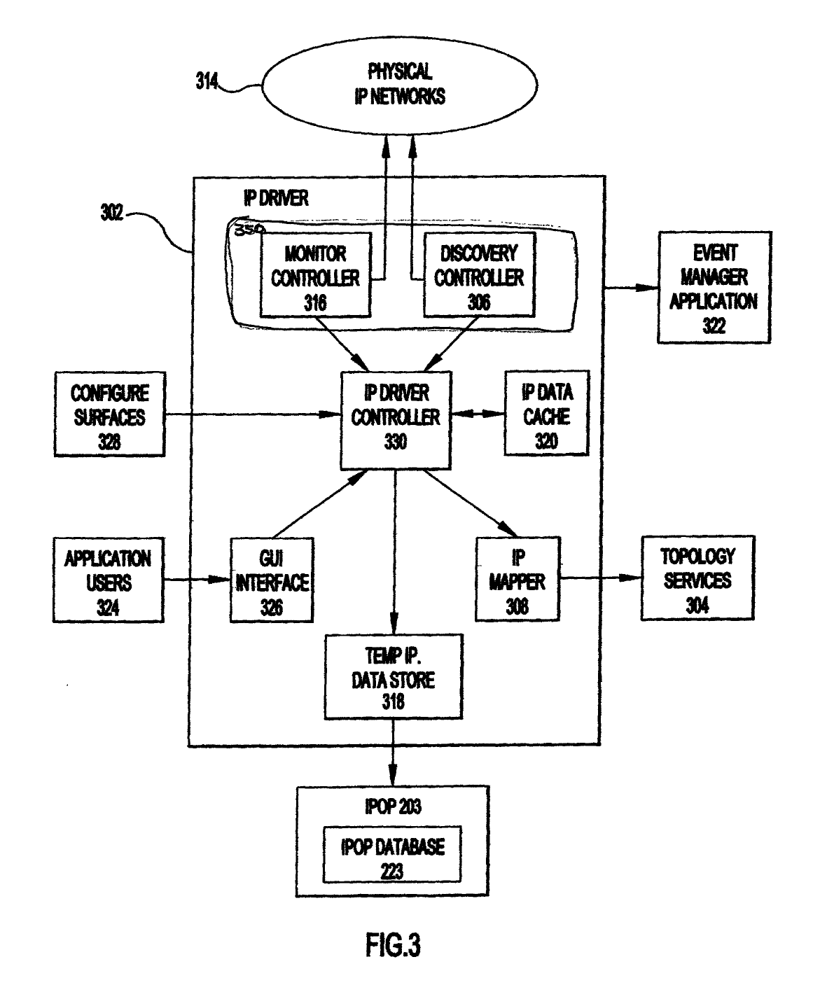

As depicted in FIG. 3, the distributed Internet Protocol (IP) Driver Subsystem 300 contains a plurality of components, including one or more IP Drivers 302 (202 of FIG. 2). Every IP Driver manages its own “scope”, described in greater detail below. Each IP Driver is assigned to a topology manager within Topology Service 304, which can serve more than one IP Driver. Topology Service 304 stores topology information obtained from the discovery controller 306 of CSPE 350. A copy of the topology information may additionally be stored at each local server DKS IPOP (see: storage location 223 of DKS IPOP 203 in FIG. 2 for maintaining attributes of discovered IP objects). The information stored within the Topology Server may include graphs, arcs, and the relationships between nodes as determined by IP Mapper 308. Users can be provided with a GUI (not shown) to navigate the topology, stored within a database at the Topology Service 304.

Discovery controller 306 of CSPE 350 detects IP objects in Physical IP networks 314 and the monitor controller 316 monitors the IP objects. A persistent repository, such as IPOP database 223, is updated to contain information about the discovered and monitored IP objects. Given the duplicated scope of discovery for the CSPEs at the distributed locations, the IPOP database will be updated at more frequent intervals from other IP Drivers. The IP Driver 302 may use temporary IP data storage component 318 and IP data cache component 320, as necessary, for caching IP objects or for storing IP objects in persistent repository 223, respectively. As discovery controller 306 and monitor controller 316 of component 350 perform detection and monitoring functions, events can be written to network event manager application 322 to alert network administrators of certain occurrences within the network, such as the discovery of duplicate IP addresses or invalid network masks.

External applications/users 324 can be other users, such as network administrators at management consoles, or applications that use IP Driver GUI interfaces 326 to configure IP Driver 302, manage/unmanage IP objects, and manipulate objects in the persistent repository 223. Configuration services 328 provide configuration information to IP Driver 302. IP Driver controller 330 serves as the central control of all other IP Driver components.

A network discovery engine is a distributed collection of IP Drivers that are used to ensure that operations on IP objects by gateways can scale to a large installation and can provide fault-tolerant operation with dynamic start/stop or reconfiguration of each IP Driver. The IPOP Service manages discovered IP objects. To do so, the IPOP Service uses a distributed system of IPOP 203 with IPOP databases 223 in order to efficiently service query requests by a gateway to determine routing, identity, and a variety of details about an endpoint. The IPOP Service also services queries by the Topology Service in order to display a physical network or map to a logical network, which may be a subnet (or a supernet) of a physical network that is defined programmatically by the Scope Manager, as detailed below. IPOP fault tolerance is also achieved by distribution of IPOP data and the IPOP Service among many endpoint Object Request Brokers (ORBs).

As taught in the co-pending patent application, one or more IP Drivers can be deployed to provide distribution of IP discovery and promote scalability of IP Driver subsystem services in large networks where a single IP Driver subsystem is not sufficient to discover and monitor all IP objects. However, where the prior approach provided that each IP discovery Driver would perform discovery and monitoring on a collection of IP resources within the driver's exclusive “physical scope”, the present invention expands a driver's scope so that multiple IP Drivers monitor/discover the same scope. A driver's physical scope is the set of IP subnets for which the driver is responsible to perform discovery and monitoring. In the past, network administrators would generally partition their networks into as many physical scopes as were needed to provide distributed discovery and satisfactory performance. Under the present invention, the performance issue is addressed by the staggering of monitoring intervals among multiple IP Drivers having the same scope. Once the scope is defined for each instance of an IP Driver, and the polling interval established with staggered polling so that no two IP Drivers are polling the same endpoint at the same time, each IP Driver will perform its monitoring on its own timetable with its own polling interval. Results of polling, however, will be available far more frequently than any one polling interval, since multiple IP Drivers are providing results at staggered intervals. Therefore, at any given time, a most recent version of polling results will be available. As an example, if a quality of service (QOS) objective is to provide updated status every minute, and the latency for one monitoring cycle is five (5) minutes, then utilizing five (5) IP Drivers in parallel configuration with each IP Driver having coextensive scope will provide updated polling results every minute.

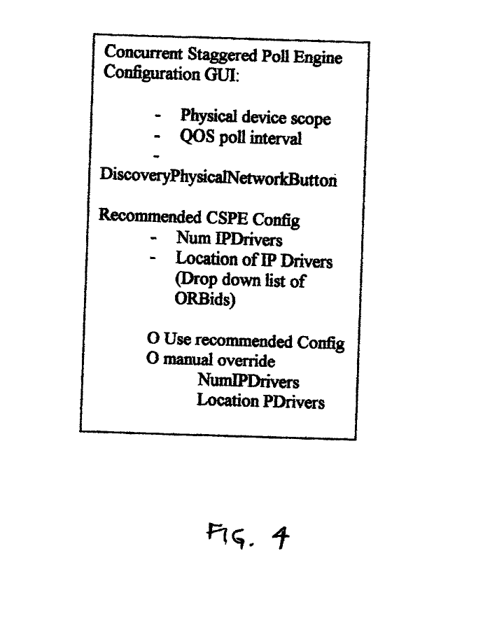

As taught in the referenced co-pending patent application, a user interface can be provided, such as an administrator console, to write scope information into the Configuration Service. FIG. 4 is a graphical user interface provided for use by a system administrator for configuring IP Drivers with coextensive scope as per the present invention. When a system adminstrator wishes to configure the distributed concurrent staggered poll engine (CSPE), the two critical variables are the IP Driver scope and the QOS polling interval. In order to define the scope, the GUI provides a “DiscoveryPhysicalNetworkButton” which will consult a previously-created topology map to assist in developing the scope information for the IP Drivers. Given the topology, the number of IP Drivers within the mapped network, and the location of those IP Drivers (using the referenced ORB IDs), a system administrator can establish the scope for the IP Drivers as well as the polling interval among the CSPEs that will effectively meet the QOS objectives for updated polling results. The GUI may access CSPE-quantifying software for calculating scope and interval values to be recommended to the system adminstrator, or can provide a “manual override” option for a system administrator to alter the recommended configuration of the monitoring system. For example, the system administrator may choose to override the value of the recommended number of IP Drivers, for example to adjust the number upward in order to exceed performance objectives. Efficient polling will be best achieved with polling of small scope groups of endpoints, so that one objective of the configuration process will be to minimize the scope. The system adminstrator may also choose to override the recommendations for the locations of instances of the CSPE due to specific latency problems or load considerations at one or more particular IP Drivers. It is to be noted that while all CSPE instances will be monitoring the same endpoints, the latency associated with one IP DRIVER versus the latency associated with another IP Driver can differ greatly based on location, load, etc. Therefore, the override option is available to the system administrator.

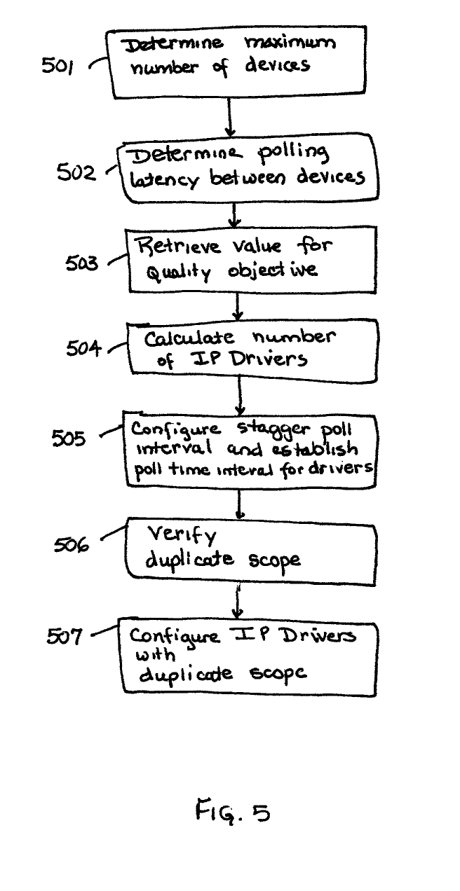

FIG. 5 is a flowchart depicting a process for configuring IP Drivers with coextensive scope as per the present invention. At step 501, the maximum number of devices is determined. The “maximum number” may represent the exact number of devices presently in the network based on an ongoing dynamic discovery process, or may, for scaleability reasons, represent an expected maximum (i.e., a theoretical limit of the network). Next, at step 502, the network link speeds between polling engines and devices are calculated to determine an expected polling latency between devices. While actual network link speeds may be stored for links between existing endpoints and existing IP Drivers, some estimating may be desired if one wishes to design toward an expanded network. It is here to be noted that instantiation of more CSPEs can be implemented later to provide for network expansion or to dynamically adjust to changing network speed or congestion. At step 503, the value of the quality of service (QOS) objective (e.g., polling updates every one minute) is obtained. Once the number of devices, link speeds, and QOS objective are available, a recommended number of needed IP Drivers can be calculated. As set forth in the example above, if a one minute update interval is the QOS objective, then the utilization of 5 IP Drivers each having an expected 5 minute polling latency and operating in staggered fashion at substantially regular start intervals should realize the objective. Once the number of IP Drivers has been calculated at 504, the stagger poll interval is established at 505 along with the poll time interval for each IP Driver. The coextensive scope is then verified at 506 to assure that no endpoints will be missed in the polling process; and, finally, the IP Drivers are configured at 507 with their scope and polling time intervals.

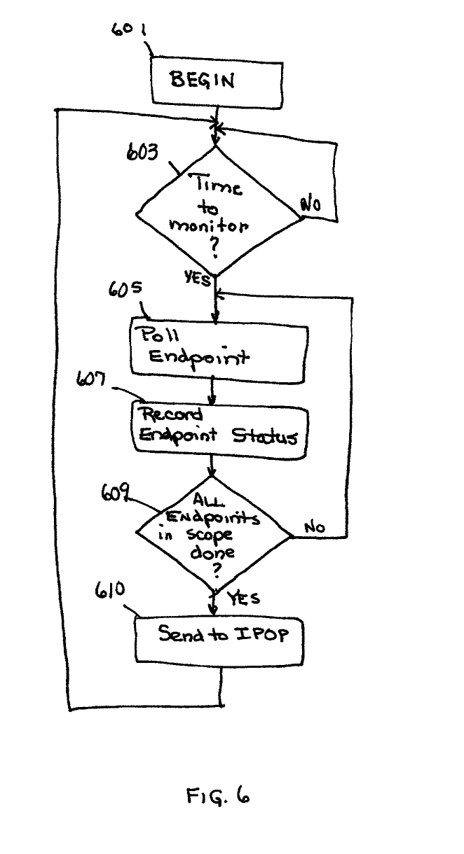

FIG. 6 is a flowchart depicting a process for implementing network monitoring in accordance with the present invention. As the CSPE at each IP Driver begins at 601, it first checks to determine if the time is equal to its “start to monitor” time (i.e., if a designated interval has elapsed) at 603. If it is time to begin monitoring, the polling engine starts to loop through all of the endpoints in its defined scope at 605. For each endpoint, the CSPE records the endpoint status at 607. If all endpoints have been polled, as determined at 609, then the polling results are sent to the IPOP (203 of FIG. 3) at 610 and the CSPE returns to await the start of its polling interval again at 603. If not all endpoints have been polled, the CSPE returns to steps 605 and 607 until a determination is made at 609 that all endpoints have been polled. It is to be noted that the distributed polling engine could provide continual input to the IPOP or could have each IP Driver provide its complete polling results upon completion of polling.

As detailed in the aforementioned co-pending patent application, an IP Driver gets its physical scope configuration information from the Configuration Service. The system administrator with CSPE defines the scopes per distributed IP Driver and stores that information at the Configuration Services for use by the IP Drivers. The scope of the physical network was used by the IP Driver in order to decide whether or not, upon discovery, to add an endpoint to its topology. The physical scope configuration information was previously stored using the following format:

ScopeID=driverID,anchorname,subnetAddress:subnetMask[:privateNetworkID:privateNetworkName:subnetPriority][, SubnetAddress:subnetMask:privateNetworkID:privateNetworkName:subnetPriority]]

A difference with the present invention is that the term “scope” has been extended to include two aspects: parallel scope and unique scope. The parallel scope is the monitoring scope, which the unique scope refers to actual scope of control. In addition, a difference with the present invention is that network objects describing both the physical and logical network will now be duplicated in IPOP. IPOP will be able to distinguish between records, however, due to the fact that uniqueness in maintained through the use of scopeID, IP address and Net address. For any updated set of polling results, the IPOP can readily determine the identity of the polling engine which provided the results. The appearance of a single polling entity is maintained for the “outside” world given the fact that all devices/endpoints within the given scope have been polled during the updated time interval.

The invention has been described with reference to several specific embodiments. One having skill in the relevant art will recognize that modifications may be made without departing from the spirit and scope of the invention as set forth in the appended claims.

Having thus described our invention, what we claim as new and desire to secure by Letters Patent is:

1. A method for configuring a distributed endpoint monitoring engine comprising a plurality of discovery engines in a distributed computing system comprising the steps of:
determining the maximum number of endpoints in said distributed computing system;
determining an expected polling latency between endpoints;
retrieving the value of the desired polling update interval;
calculating a recommended number of discovery engines needed to provide the desired polling update interval based on the number of endpoints, the expected polling latency and the desired polling update interval; and
configuring the distributed engine based on said recommended number of discovery engines.

2. The method of claim 1 wherein said configuring said distributed engine comprises the steps of:
selecting a chosen number of discovery engines; and
establishing a poll time interval for each of the chosen engines.

3. The method of claim 2 further comprising establishing a staggered schedule for activating each of said chosen engines.

4. The method of claim 1 further comprising identifying a coextensive monitoring scope for each of said chosen engines.

5. The method of claim 4 further comprising verifying that all endpoints are encompassed by said coextensive monitoring scope.

6. The method of claim 4 further comprising communicating said coextensive monitoring scope and said poll time interval to each of said chosen engines.

7. The method of claim 1 wherein said determining the maximum number comprises dynamic discovery of the actual number of endpoints.

8. The method of claim 1 wherein said determining the maximum number comprises estimating an expected maximum.

9. The method of claim 1 wherein said determining the expected polling latency is based on at least one of actual link speed, theoretical link speed, actual endpoint speed and theoretical endpoint speed.

10. A method for implementing distributed endpoint monitoring in a distributed network comprising the steps of:
determining a coextensive monitoring scope for each of a plurality of distributed discovery engines;
determining a poll time interval for each of said plurality of distributed discovery engines;
configuring each of said plurality of distributed discovery engines with said coextensive monitoring scope and poll time interval;
establishing a staggered schedule for starting each of said plurality of distributed discovery engines; and
implementing said staggered schedule.

11. The method of claim 10 further comprising each of said plurality of distributed discovery engines monitoring said coextensive monitoring scope over its poll time interval.

12. The method of claim 11 wherein each of said plurality of distributed discovery engines communicates monitoring results to a central database.

13. The method of claim 10 wherein said determining a coextensive scope comprises the steps of:
determining the maximum number of endpoints in said distributed computing system;
determining an expected polling latency between endpoints;
retrieving the value of the desired polling update interval;
calculating a recommended number of discovery engines needed to provide the desired polling update interval based on the number of endpoints, the expected polling latency and the desired polling update interval; and
configuring the distributed engine based on said recommended number of discovery engines.

14. A program storage device readable by machine tangibly embodying a program of instructions executable by the machine to perform method steps for configuring a distributed endpoint monitoring system comprising a plurality of distributed discovery engines, said method comprising the steps of:
determining the maximum number of endpoints in said distributed computing system;
determining an expected polling latency between endpoints based on network link speeds;
retrieving the value of the desired polling update interval;
calculating the number of distributed discovery engines needed to provide the desired polling update interval based on the number of endpoints, the expected polling latency and the desired polling update interval; and
establishing a poll time interval for each of the distributed discovery engines.

15. The program storage device of claim 14 wherein said method further comprises establishing a staggered schedule for activating each of said distributed discovery engines.

16. The program storage device of claim 14 wherein said method further comprises identifying a coextensive monitoring scope for each of said distributed discovery engines.

17. The program storage device of claim 16 wherein said method further comprises verifying that all endpoints are encompassed by said coextensive monitoring scope.

18. The program storage device of claim 16 wherein said method further comprises communicating said coextensive monitoring scope and said poll time interval to each of said distributed discovery engines.

19. The program storage device of claim 14 wherein said determining the maximum number comprises estimating an expected maximum.

20. A program storage device readable by machine tangibly embodying a program of instructions executable by the machine to perform method steps for monitoring network endpoints in a distributed network, wherein said method comprises the steps of:
determining a coextensive monitoring scope for each of a plurality of distributed discovery engines;
determining a poll time interval for each of said plurality of distributed discovery engines;
configuring each of said plurality of distributed discovery engines with said coextensive monitoring scope and poll time interval;
establishing a staggered schedule for starting each of said plurality of distributed discovery engines; and
implementing said staggered schedule.

21. The program storage device of claim 20 wherein said method further comprises each of said plurality of distributed discovery engines monitoring said coextensive monitoring scope over its poll time interval.

22. The program storage device of claim 21 wherein each of said plurality of distributed discovery engines communicates monitoring results to a central database.

23. A network monitoring system for a plurality of endpoints in a distributed computing system comprising:
a plurality of distributed discovery engines each configured to monitor the same plurality of endpoints during a predetermined poll time interval, to produce a poll output, and to provide the poll output to a central repository; and
a central repository for receiving said poll output.

24. The system of claim 23 further comprising at least one concurrent polling engine component for identifying the plurality of endpoints for monitoring.

25. The system of claim 24 wherein said at least one concurrent polling engine component is additionally adapted to establish a plurality of poll time intervals for said plurality of distributed discovery engines.

26. The system of claim 25 wherein said at least one concurrent polling engine component is adapted to create a staggered polling schedule comprising said plurality of poll time intervals.

27. In a distributed computing system comprising a plurality of endpoints and at least two system locations, an improved monitoring system comprising a distributed concurrent staggered polling engine distributed at said at least two system locations.
